(19) United States
(12) Patent Application Publication
(10) Pub. No.: US 2007/0261076 A1
(43) Pub. Date: Nov. 8, 2007

(54) Conditional Access System

(76) Inventor: Matti Puputti, Turku (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/598,627

(22) PCT Filed: Feb. 22, 2005
(86) PCT No.: PCT/IB05/50644

§ 371 Date: Jun. 13, 2007

(30) Foreign Application Priority Data
Mar. 10, 2004 (GB) 0405422.7

(51) Int. Cl. H04N 7/16

(52) U.S. Cl. 725/25

(57) ABSTRACT

A conditional access system in which entilement management messages (EMMs) sent to a receiver include transmission time information for future EMMs. The transmission time information is used at the receiver to control the receiver so that it is powered on only when required to receive the future EMMs.

### FIELD OF THE INVENTION

The present invention relates generally to the field of conditional access systems, particularly but not exclusively to a conditional access system in which entitlement management and control messages (EMMs/ECMs) include information about future message transmission times.

### BACKGROUND

Conditional access systems are well known and widely used in conjunction with currently available pay television systems. At present, such systems are based on the transmission of programmes scrambled with control words that are received by subscribers having a set-top box and a smart card for each subscription package. The smart card for a subscription package from a particular service provider allows the scrambled programmes within the package to be descrambled and viewed. The broadcast stream further contains entitlement management messages and entitlement control messages, which are necessary for the smart card to descramble the broadcast.

WO 98/43426 discloses a digital satellite television system in which entitlement control messages which contain the control word in an encrypted format are sent to a set-top box via the broadcast channel while entitlement management messages are sent to the set-top box via a modem based back channel. The control word is decrypted at the set-top box by means of a smart card.

Since the control word is the primary security mechanism for protecting the broadcast, it is changed relatively frequently, for example, every two seconds, so that entitlement control messages must be sent at least this frequency. In contrast, entitlement management messages are used to convey encryption keys and to notify subscription rights to a user or to invalidate such keys and rights. As a result, they need only be sent relatively infrequently, for example, once a week or once a month. Therefore, even when a receiver is not receiving a broadcast, it needs to maintain a constantly active listening state to receive entitlement management messages sent to it by the broadcaster. This is inherently inefficient and wasteful of power.

U.S. Pat. No. 6,584,199 discloses a conditional access system in which a satellite channel is used to inform a receiver of a transmission time of a receive control message (RCM) and/or entitlement management message (EMM) which is non-periodically transmitted at a predetermined time. The receiver is automatically powered on at the predetermined time to allow it to receive and decode the messages. A resource subscriber management system predetermines a time for transmitting the RCM/EMM message to the receiver and informs the receiver of this predetermined time prior to and separately from the RCM/EMM message. At the predetermined time, the transmitter sends the RCM/EMM message, while the receiver powers up ready to receive the message. However, this requires a separate transmission to set up the receiver to receive the RCM/EMM messages.

U.S. Pat. No. 6,584,199 does not envisage a mechanism for permitting a mobile roaming receiver to receive the time information.

### SUMMARY OF THE INVENTION

The present invention aims to address the above problems.

According to the present invention, there is provided a conditional access system comprising a transmitter for transmitting a plurality of control messages relating to a broadcast stream to a receiver, each of said control messages being associated with information relating to a transmission time for control messages that are to be transmitted in the future.

By associating the time information with the control messages, for example, by applying a time stamp to each of the control messages including information relating to a transmission time of the next control message in the sequence, there is no need to transmit the time information separately.

The transmission time information may comprise information relating to the transmission time of the next control message to be transmitted or may comprise a schedule of transmission time information for future control messages.

In alternative embodiments, transmission time information may comprise information defining the transmission time of the next control message that contains content different from content previously transmitted. The receiver does not therefore have to be on to receive repeated content, but can be turned on selectively to receive control messages containing new content only.

The control messages typically comprise entitlement management messages, which are sent relatively infrequently in a conditional access system and therefore give the greatest scope for power saving. However, the inventive scheme can be extended to any other form of message, including entitlement control messages, where a resource saving, such as a power saving, can be made by the receiver knowing the transmission time of the message in advance.

In addition to the transmission time information, the information transmitter may further include information defining transmission parameters for the control messages, such as information on the bearers, or on the networks or on the operators providing the control messages.

According to the invention, there is also provided a receiver for use in a conditional access system, comprising an input module for receiving a plurality of control messages relating to broadcast content, each of said control messages being associated with time information relating to a transmission time for control messages which are to be transmitted to the receiver in the future; and means for selectively activating the receiver to receive the future control messages at the transmission time.

The selective activation means may include a processor module for extracting the transmission time information from said control messages and a controller for setting a power-up time for the receiver based on said transmission time information. By switching off the receiver until the power-up time is reached, it may be possible to realise a considerable power saving.

The receiver may be a mobile receiver, so allowing the possibility of roaming between networks that are accessible to the receiver. A mobile receiver may be configured to request a transmission time schedule from a home network operator and receive the schedule independently of the control messages.

According to the invention, there is further provided a method for use in a conditional access system, in which a receiver is operable to receive a plurality of control messages that are associated with transmission time information relating to a transmission time of future control messages, the method comprising selectively activating the receiver to receive the future control messages at the transmission time.

According to the invention, there is still further provided a conditional access system, comprising a transmitter for transmitting a plurality of control messages, each of the messages including information relating to a predetermined transmission time for future control messages, a receiver for receiving the control messages; and means for selectively activating the receiver to receive the future control messages at the predetermined time.

According to another aspect of the invention, there is provided a mobile transceiver for use in a conditional access system, the mobile transceiver being configured to request transmission time information for conditional access messages to be transmitted in the future, the transceiver further being configured to receive the transmission time information and to use the information to set a time for turning on a receiver to receive the messages at a time that substantially coincides with the future conditional access message transmission time.

The mobile transceiver may be used to receive messages such as SMS and MMS messages via a mobile telephone network, the message including the transmission time information. The user can respond to such messages by manually switching on or setting up the receiver to receive the conditional access messages. In an alternative embodiment, the mobile transceiver is connected to the receiver and transfers the messages to a timing module of the receiver when the mobile transceiver is switched on.

According to a further aspect of the invention, there is provided a method of operating a mobile transceiver in a conditional access system, the mobile transceiver being configured to request transmission time information for conditional access messages to be transmitted in the future, the transceiver further being configured to receiver the transmission time information, the method comprising turning on a receiver to receive the messages at a time that substantially coincides with the future conditional access message transmission time.

According to a still further aspect of the invention, there is provided a subscription authorisation system for use in a conditional access system to provide a plurality of control messages to a receiver, the control messages relating to a service provided to the receiver by a service provider, each of said control messages being associated with information relating to a transmission time for control messages that are to be transmitted in the future. The control messages may therefore be provided by the service provider, while the transmission of the messages can be handled by a separate entity. In this case, the control messages are provided from the service provider to a transmitter for onward transmission to the receiver.

### BRIEF DESCRIPTION OF THE DRAWINGS

Embodiments of the invention will now be described, by way of example, with reference to the accompanying drawings, in which:

FIG. 1 is a schematic diagram of a prior art conditional access system in which entitlement control messages and entitlement management messages are integrated into a broadcast stream;

FIG. 2 is a schematic diagram illustrating a prior art conditional access system in which entitlement control messages are integrated into the broadcast stream but entitlement management messages are sent via a separate channel;

FIG. 3 is a schematic diagram illustrating a conditional access system according to one embodiment of the invention in which entitlement management messages are time stamped;

FIG. 4 is a schematic diagram of the EMM message receiver according to an embodiment of the invention shown in FIG. 3;

FIGS. 5 and 6 are exemplary flow diagrams illustrating the operation of the system shown in FIGS. 3 and 4;

FIG. 7 is a schematic diagram illustrating a conditional access system according to another embodiment of the invention in which an interaction channel permits the user to obtain information relating to the next time that the conditional access management messages are due to be delivered; and

FIG. 8 is a schematic diagram illustrating a conditional access system according to still another embodiment of the invention in which a mobile phone transceiver is used to obtain conditional access management message transmission times.

### DETAILED DESCRIPTION

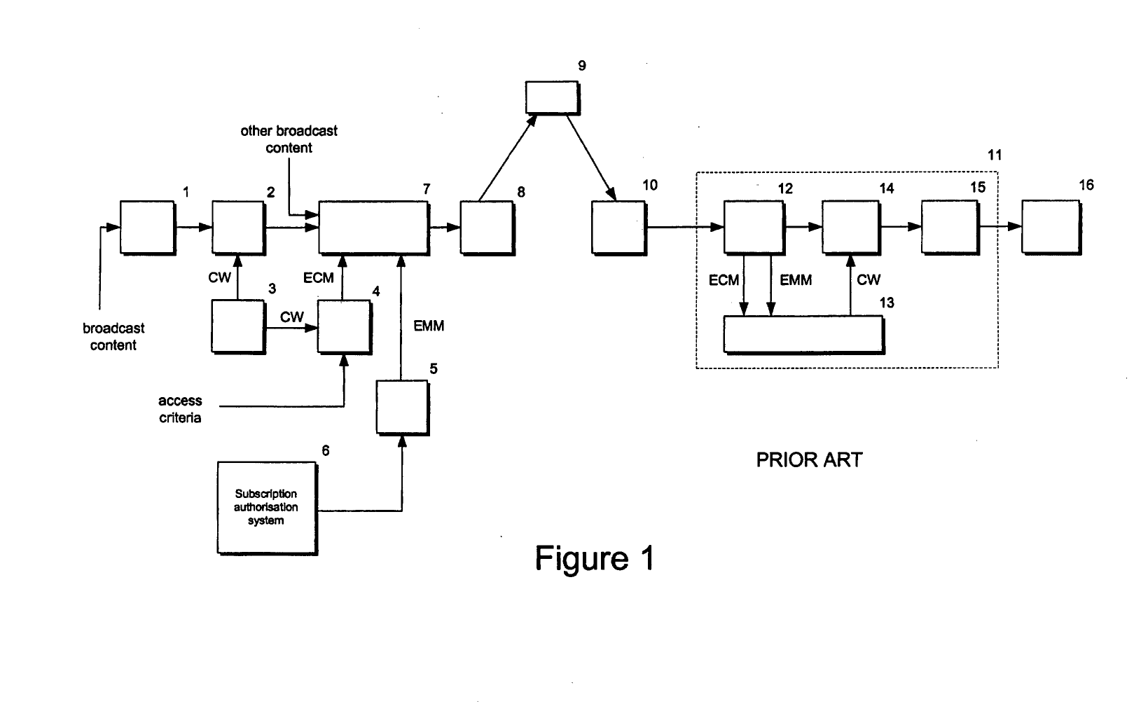

Referring to FIG. 1, in a conventional conditional access system, content to be broadcast, including for example, video, audio and data components, is encoded in an encoder 1 using an appropriate coding system, for example MPEG-2 for digital broadcasting. The encoded broadcast stream is scrambled in a scrambler 2 under the control of a control word CW generated by a control word generator 3 in a manner which is well-known per se. The control word is encrypted into an Entitlement Control Message (ECM) by an ECM generator 4 together with access criteria which identify the service and the conditions required to access the service. For example, the access criteria may specify regional limitations on the broadcast. A further type of message, referred to as an Entitlement Management Message (EMM), which carries details of the subscriber and his subscription is generated by an EMM generator 5 based on subscription information received from a subscription authorisation system 6. While an ECM message is associated with a scrambled programme or set of programmes and carries the information required to decrypt those programmes, an EMM message is a message dedicated to an individual user or group of users and carries the information necessary to determine whether those users have the necessary subscriptions in place to be able to view the programmes.

The scrambled encoded broadcast stream together with the ECM and EMM messages is multiplexed in a multiplexer 7 with other broadcast streams representing other programmes, together making up a subscription package from a particular service provider. The package is sent to a transmitter 8 from which it is transmitted, via a communications channel 9, for example a satellite, cable or terrestrial channel, using an appropriate modulation scheme, for example, in accordance with the digital video broadcasting DVB standards. The scrambled encoded broadcast stream is received at a subscriber's receiver 10, for example a DVB receiver, and passed to the subscriber's set-top box 11.

On receipt at a set-top box (STB) 11, the received data is demultiplexed in a demultiplexer 12, to extract the required programme and its associated ECM and EMM messages. The extracted ECM and EMM messages are sent to a plug-in smart card 13. The smart card 13 uses the ECM and EMM messages to determine whether the subscriber has the right to view the broadcast and if so, to decrypt the control word CW, which is input to a descrambler 14 together with the scrambled broadcast stream to recover the original MPEG-2 encoded broadcast stream. The encoded stream is passed to an MPEG-2 decoder 15 which produces an output signal comprising audio, video and data components for display on the subscriber's television display 16.

The control word may comprise alternating odd and even control words that are alternated at, for example, two second intervals. Each control word is changed at predetermined intervals, for example, every twenty seconds. A continuous stream of ECM messages is therefore required to descramble the scrambled signal. The EMM messages can be updated much less frequently, for example once a week or once a month.

The conventional form of ECM and EMM messages is defined in the international standard ISO IEC 13818-1:2000(E), “Information technology—Generic coding of moving pictures and associated audio information: Systems”.

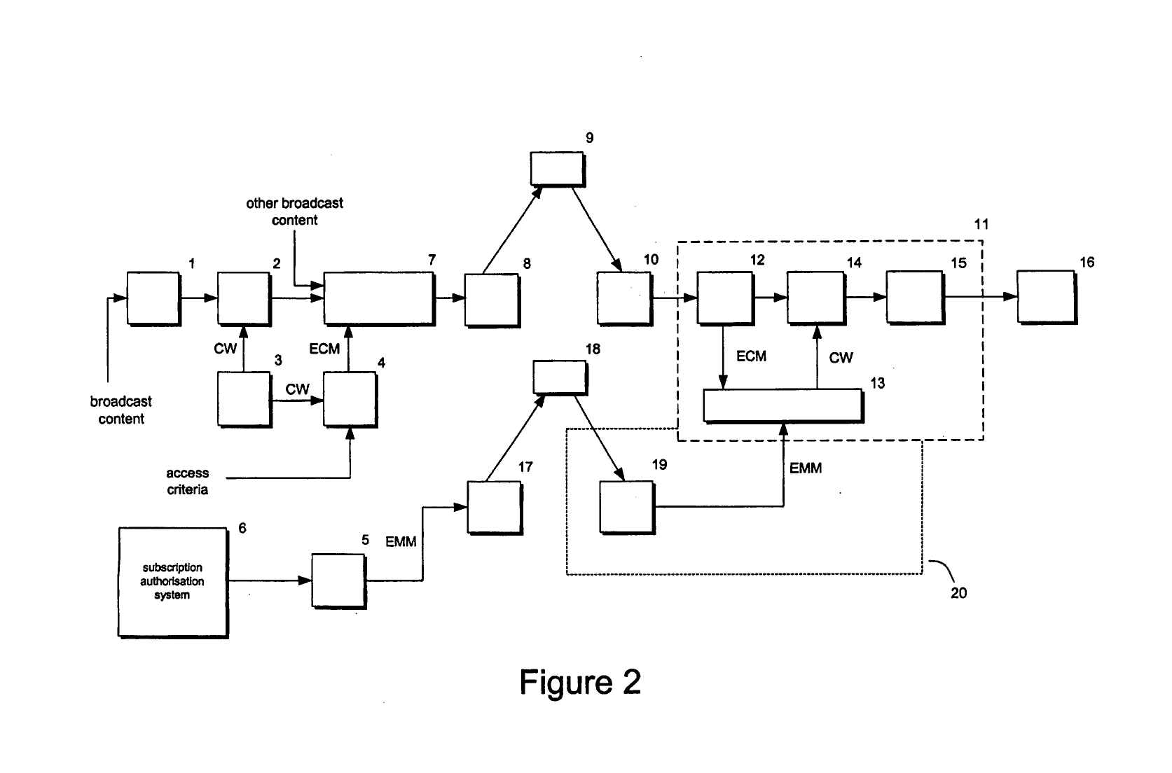

FIG. 2 shows a modified conditional access system, in which the EMM messages are not multiplexed into the broadcast stream but are instead transmitted to the set-top box 11 via a channel separate from the broadcast channel. An EMM generator 5 generates an EMM message in the usual way. The EMM message is not multiplexed into the broadcast stream, but is sent to a second transmitter 17, from where it is transmitted by a second communications channel 18 to a second receiver 19. The EMM message is passed from the second receiver 19 to the smart card 13. As with the system described with reference to FIG. 1 above, this enables the smart card 13 to recover the code word CW and therefore to descramble the broadcast stream for display on the subscriber's television 16.

The separate channel can be any suitable communications channel.

While FIG. 2 shows the second receiver 19 as separate from the set-top box 11, the second receiver 19 may be located within the set-top box 11, as shown by the dotted line marked 20 in FIG. 2.

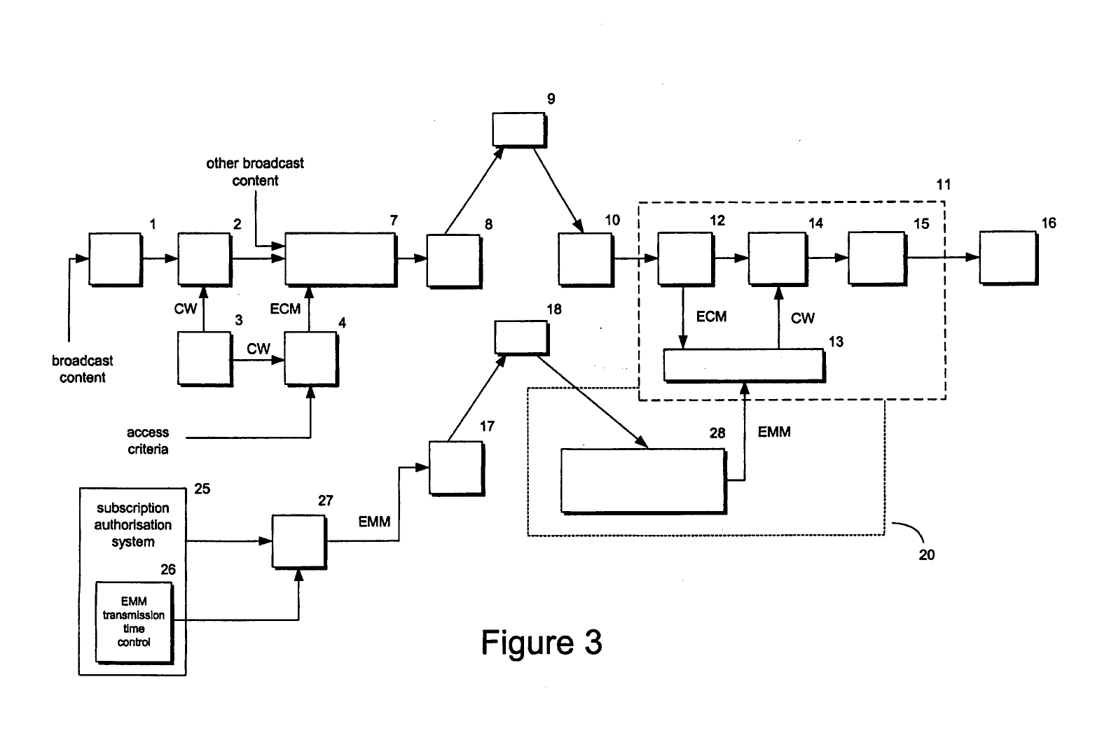

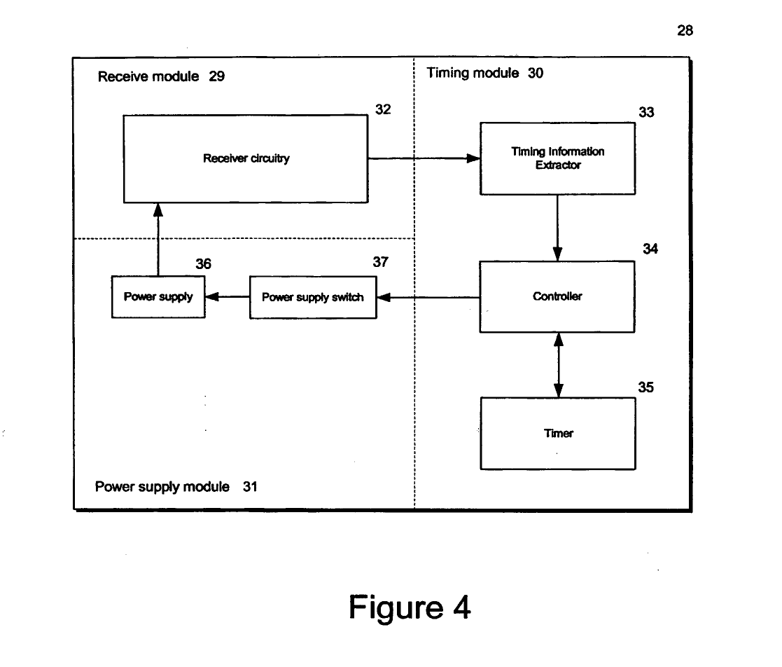

FIG. 3 is a modification of FIG. 2, illustrating a conditional access system according to the invention. In this system, a subscription authorisation system 25 maintained by, for example, a service provider, includes an EMM transmission time controller 26 that provides EMM transmission time information to an EMM generator 27. An EMM receiver 28 includes circuitry for receiving and processing the transmission time information, as shown in more detail in FIG. 4.

The second communications channel 18 in this example can comprise a virtual private network (VPN), a cellular telephone network such as a GSM, UMTS or GPRS network, a conventional PSTN point-to-point telephone connection, a DSL connection, a secure HTTPS socket connection over the Internet, another IP based network, for example using streaming media, or a network based on a different protocol or any other form of communications link over satellite, cable, by terrestrial transmission or otherwise, for example a DVB channel operating according to the DVB-S, DVB-C, DVB-T or DVB-H specifications.

FIG. 4 is a schematic illustration of the receiver 28 required to process the transmission time information included with the EMMs. The receiver 28 includes a receive module 29, a timing module 30 and a power supply module 31. The receive module 29 includes conventional receiver circuitry 32, for example a DVB receiver 32 for receiving and demodulating a DVB transmission and therefore recovering the EMM message from the transmission channel 18. It will be understood that the form of the receiver circuitry depends on the requirements of the transmission channel over which the EMM message is transmitted.

The timing module 30 includes a timing information extractor 33, a controller 34 and a timer 35. The power supply module 31 includes a power supply 36 and a power supply switching module 37. While reference is generally made to modules, the skilled person will appreciate that embodiments of the invention can be implemented in any suitable form, for example, in hardware, software or any combination of the two. For example, in one embodiment, the timing module 30 comprises a processor and memory with software in the memory for implementing the timing control functionality.

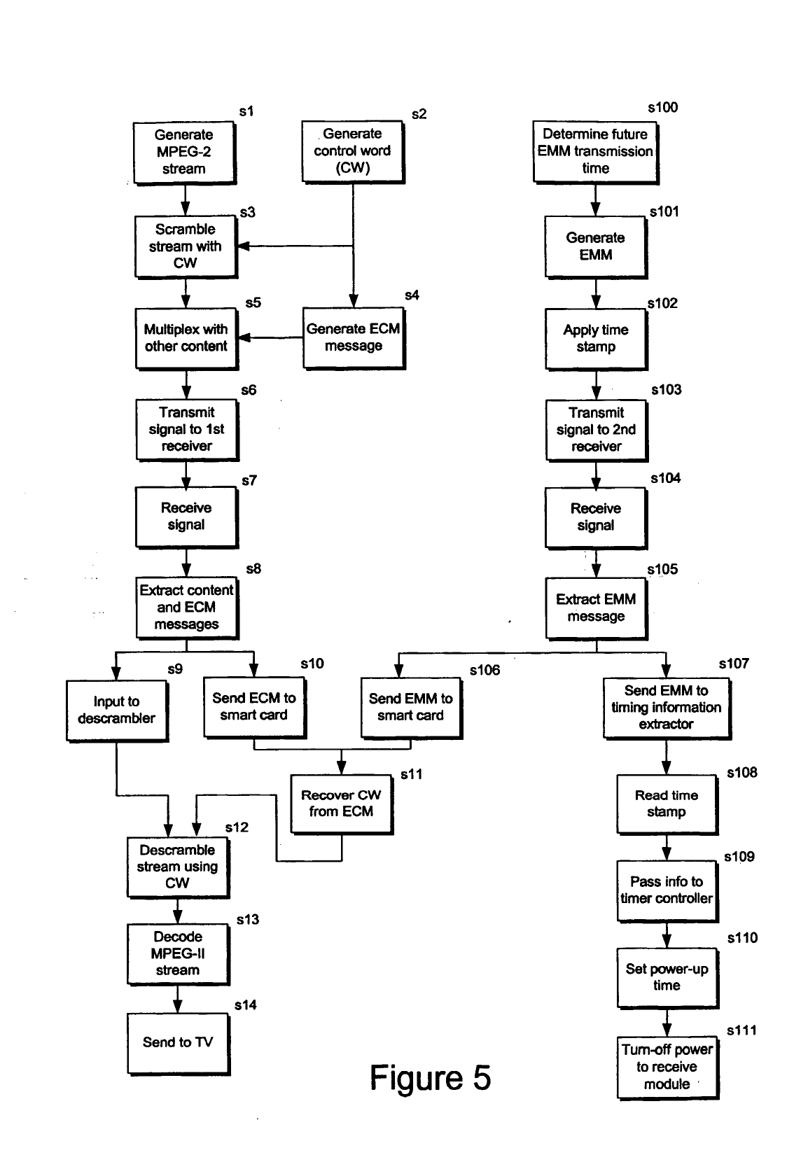

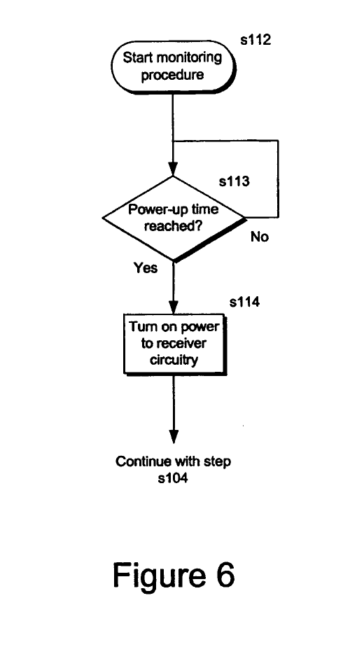

The operation of the system of FIGS. 3 and 4 is explained in detail with reference to the flow charts shown in FIGS. 5 and 6.

Referring to FIG. 5, the operation of the broadcast/ECM transmission portion of the system is essentially the same as that described above in relation to FIG. 1. More particularly, broadcast content including, for example, video, audio and data components, is encoded in an encoder 1 using an appropriate coding system, for example MPEG-2 for digital broadcasting (step s1). A control word is generated by the control word generator 3 (step s2) and the encoded broadcast stream is scrambled in the scrambler 2 under the control of the control word CW (step s3). The control word is also encrypted into an Entitlement Control Message (ECM) by an ECM generator 4 together with access criteria which identify the service and the conditions required to access the service (step s4). For example, the access criteria may specify regional limitations on the broadcast. The scrambled encoded broadcast stream together with the ECM message is multiplexed in a multiplexer 7 with other broadcast streams representing other programmes, together making up a subscription package from a particular service provider (step s5). The package is sent to a transmitter 8 from which it is transmitted (step s6), via a communications channel 9, for example a satellite, cable or terrestrial transmission channel, using an appropriate modulation scheme. For example, in one embodiment of the invention, the transmission channel conforms to the DVB-T specification. In other embodiments, the transmission channel can conform to the DVB-S, DVB-C or DVB-H specifications.

On receipt at the set-top box (STB) 11 (step s7), the received data is demultiplexed in a demultiplexer 12, to extract the required programme and its associated ECM messages (step s8). The broadcast content is sent to the descrambler 14 (step s9), while the extracted ECM messages are sent to the plug-in smart card 13 (step s10).

The encoded broadcast stream cannot be descrambled without the assistance of the entitlement management messages (EMMs), which are sent considerably less frequently than the ECM messages. When received, an EMM message is stored in the smart card until the next EMM message is received to replace it.

The EMM transmission time controller 26 in the service provider's subscription authorisation system 25 provides time information defining the time at which a future EMM message will be transmitted (step s100). For example, the EMM transmission time controller 26 provides a schedule of EMM message transmission times over a particular period. This schedule may include the time of the next individual EMM message, i.e. a message sent to the client equipment only, the time of the next group EMM message, i.e. a message sent to the group to which the client equipment belongs and the time of the next broadcast EMM message, i.e. a message sent to all clients. The client equipment comprises, for example, a smart card. The EMM transmission time controller 26 may also provide other associated information, for example, information on the bearers, networks and/or operators providing the next EMM messages.

The EMM generator 27 generates an EMM message (step s101) and applies the received time information to the generated EMM message as a time stamp (step s102), defining the transmission time for the EMM message following the current message, or, in another embodiment, defining transmission times for the next individual, group and broadcast messages. In other embodiments, the time information can be incorporated into or associated with the EMM message in any suitable manner, for example as an attachment.

The time stamped EMM message is sent to the second transmitter 17, from where it is transmitted via the second communications channel 18 to the second receiver 28 (step s103).

On receipt by the second receiver 28 (step s104), the signal is demodulated and the EMM message extracted (step s105) and the extracted message is sent to the smart card 13 for further processing (step s106). At the same time, the EMM message is also passed to the timing information extractor 33 within the timing module 30 (step s107). The way in which the timing information is processed will be described in detail below.

Once the smart card 13 has both the EMM and ECM information, the descrambling of the broadcast stream proceeds in substantially the same way as described above with reference to FIG. 1. The smart card 13 uses the ECM and EMM messages to determine whether the subscriber has the right to view the broadcast and if so, to decrypt the control word CW (step s11), which is input to the descrambler 14 together with the scrambled broadcast stream to recover the original MPEG-2 encoded broadcast stream (step s12). The encoded stream is decoded in the MPEG-2 decoder 15 (step s13), which produces an output signal comprising audio, video and data components for display on the subscriber's television 16 (step s14). Returning to the operation of the timing module 30, the timing information extractor 33 reads the time stamp on the EMM message (step s108) and passes this to the controller 34 (step s109). The controller 34 sets the timer 35 to a power up time based on the time specified in the timing information (step s110) and instructs the power supply switching module 37 to turn off the power supply 36 to the receiver circuitry 32 (step s111). For example, the power up time takes into account any internal delays in powering up the receiver circuitry 32, and is therefore set to be shortly before the indicated EMM transmission time, so that the receiver is fully powered up when the EMM message is sent. The monitoring of the timer to permit power up at the appropriate time is illustrated in FIG. 6, starting from step s112.

Referring to FIG. 6, the controller 34 periodically checks whether the timer has reached the power up time (step s113). If not, it continues to monitor the timer. When the timer 35 reaches the power up time, the controller 34 sends a control signal to the power supply switching module 37 to turn on the power supply 36 to the receiver circuitry 32, ready to receive the next EMM message (step s114). The receiver circuitry 32 will therefore power up shortly before the EMM message is due to be sent, so minimizing receiver power. The procedure then continues from step s104 shown in FIG. 5.

The EMM transmission time controller 26 may generate and the EMM generator 27 may include the EMM message transmission time schedule with each EMM message, so that the receiver knows not only the transmission time of the next EMM message but also future transmission times over any predetermined period.

In the event that the broadcast receiver is a mobile receiver, capable of roaming between networks, other practical difficulties may arise. For example, the home network may need to know where the receiver, also referred to as a client, is, while the roamed network may need to know what clients are on its network.

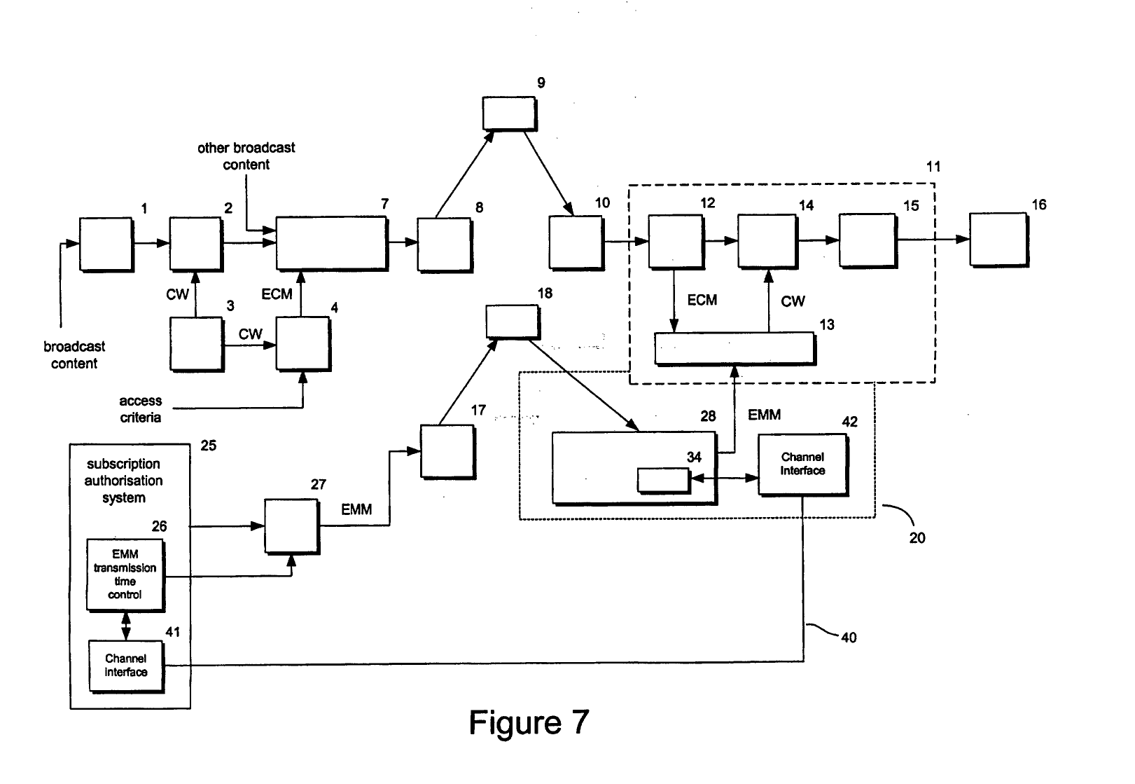

In a further embodiment of the invention illustrated in FIG. 7, an interaction channel 40 is provided between the receiver 28 and the authorisation system 25 to permit the client to call the home network and indicate its current access network. Suitable interfaces 41, 42 are provided at each end of the channel. In this example, the client calls the home network authorisation system 25 and requests the EMM transmission time schedule. The authorisation system 25 sends back a schedule with the required information, for example the next individual, group and broadcast EMM message times. In this example, the EMM messages can then be sent through the main broadcast channel 9, by analogy with the system shown in FIG. 1, by the separate EMM transmission channel 18 shown in FIG. 7, or over the interaction channel in a suitable format, for example as an SMS or MMS message where the interaction channel comprises a mobile phone network.

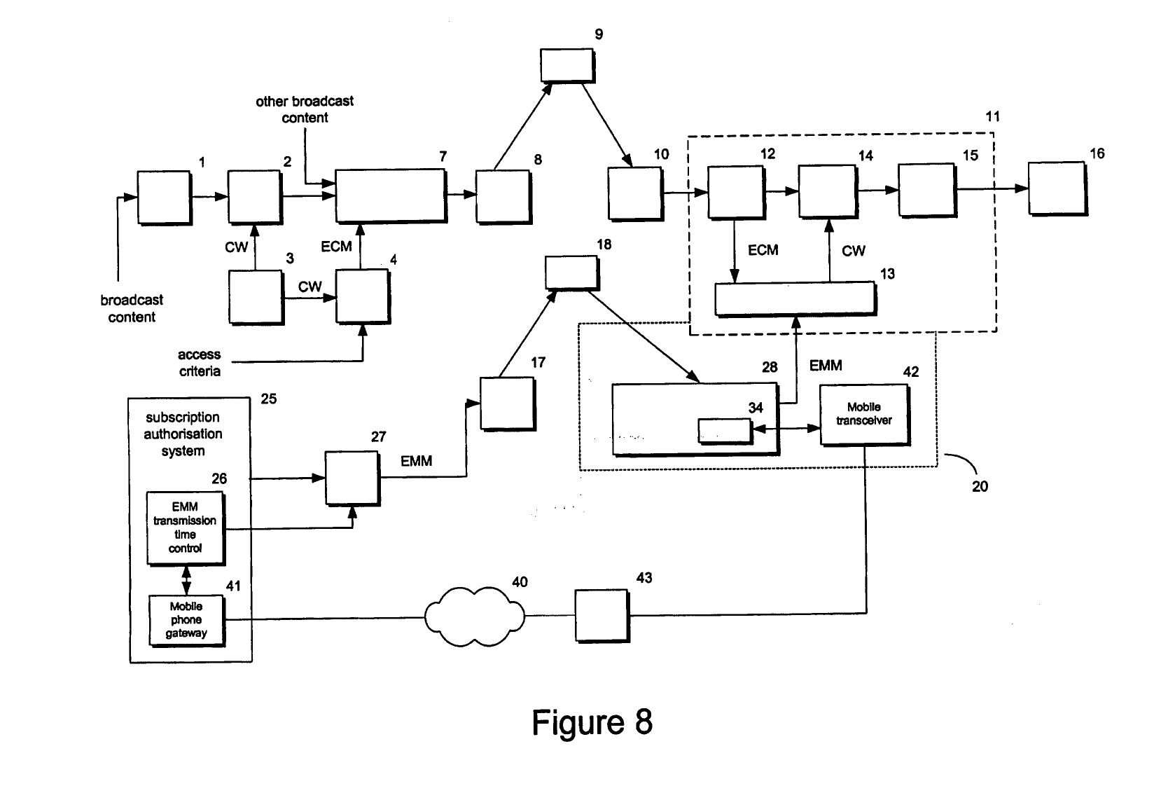

One specific example of an interaction channel 40 is shown in FIG. 8. The channel interface 42 comprises a mobile transceiver 42 that connects to a mobile phone network 40 to request transmission time information from the subscription authorisation system 25 via a mobile phone gateway 41. The transmission information is sent to the mobile transceiver using a messaging system such as MMS or SMS. In the event that the mobile transceiver 42 is switched off, the message is held for a user defined period of time at an SMS gateway 43. Whenever the mobile transceiver 42 is switched on, the SMS message can be downloaded and used as the basis for the user to turn on the EMM message receiver part 28 of the system or to set-up the receiver 28 to switch on at the appropriate time.

In other embodiments of the invention, the mobile transceiver comprises a protected processing environment that can be used instead of the smart card to receive both ECM and EMM messages and to provide the control word in response.

The receiver-transceiver combination can alternatively be a mobile user terminal, for example, as described in and with reference to FIG. 2 of our co-pending GB patent application no. 0328249.8, which is incorporated herein by reference in its entirety. By carrying out the ECM/EMM processing within the device controller, the functionality of the STB and TV display can also be included in the user terminal.

It is also envisaged that, in an alternative embodiment, the mobile transceiver comprises a mobile telephone 42 separate from the EMM receiver 28. In this case, the user can request transmission time information by calling the subscription authorisation system 25 and on receipt of the information, can manually switch on or configure the EMM receiver 28. Alternatively, the user can connect the mobile phone 42 to the EMM receiver 28 by an appropriate connection technology, for example by an infra-red, Bluetooth™, cable or other wired connection.

In the above description, the transmission of the EMM messages to the smart card has primarily been described, for clarity, as being via a channel separate from the broadcast channel. However, the skilled person will appreciate that transmission of the EMMs over the broadcast channel is also covered. When no service is being received, the broadcast receiver 10 can be switched off until the time for transmission of the next EMM message. The broadcast receiver may, for example, be a fixed receiver operating according to the DVB-T specification, or a mobile receiver operating according to the DVB-H specification.

It will further be appreciated that, while the above description is primarily concerned with transmission time information for entitlement management messages, it also applies to other types of management and control messages, including entitlement control messages ECMs. For example, in some systems, ECM messages may be sent frequently, such as every second, but their content may be changed less frequently, for example every ten seconds. An ECM message may include information on the timing or schedule of the next ECM messages or when the next changed ECM message for the service is due to be transmitted. This may be useful in reducing the power requirements in, for example, a mobile receiver in which the ECM and EMM messages are separated from the broadcast stream, to allow the receiver to be turned on only when a new ECM or EMM message is being received. In this context, a new ECM or EMM message means a message the content of which differs from that of previously received messages.

Finally, it will also be appreciated that embodiments of the invention can cater for possible time zone differences. In particular, the receiver may be in a different time zone as compared with the EMM transmission time transmitter. Universal time (UTC) may be used on the schedules or the schedules may be changed into local time, which may be received from a network to which the receiver or transceiver are connected.

1. A conditional access system comprising a transmitter for transmitting a plurality of control messages relating to a broadcast stream to a receiver, each of said control messages being associated with information relating to a transmission time for control messages that are to be transmitted in the future.

2. A conditional access system according to claim 1, wherein said control messages include the future transmission time information.

3. A conditional access system according to claim 1, wherein the transmission time information comprises information relating to the transmission time of the next control message to be transmitted.

4. A conditional access system according to claim 1, wherein the transmission time information comprises a schedule of transmission time information for future control messages.

5. A conditional access system according to claim 1, wherein the transmission time information comprises information defining the transmission time of the next control message that contains content different from content previously transmitted.

6. A conditional access system according to claim 1, wherein said control messages are intended for a specified address and the future transmission time information comprises information as to when future messages are to be sent to the specified address.

7. A conditional access system according to claim 6, wherein the specified address comprises an address of a smart card, a predetermined group of smart cards or all smart cards.

8. A conditional access system according to claim 1, wherein the control messages comprise entitlement management messages.

9. A conditional access system according to claim 1, wherein the control messages comprise entitlement control messages.

10. A conditional access system according to claim 1, wherein the transmitter is also configured to transmit the broadcast stream.

11. A conditional access system according to claim 1, wherein the transmitter for transmitting the control messages comprises a first transmitter and the system further comprises a second transmitter for transmitting the broadcast stream.

12. A conditional access system according to claim 11, wherein the control messages sent from the first transmitter comprise entitlement management messages.

13. A conditional access system according to claim 12, wherein the broadcast stream includes entitlement control messages.

14. A conditional access system according to claim 1, wherein the transmission time information further comprises information defining transmission parameters for the control messages.

15. A conditional access system according to claim 14, wherein the transmission parameters include information on the bearers, or on the networks or on the operators providing the control messages.

16. A receiver for use in a conditional access system comprising:
an input module for receiving a plurality of control messages relating to broadcast content, each of said control messages being associated with time information relating to a transmission time for control messages which are to be transmitted to the receiver in the future; and
a selective activation module for selectively activating the receiver to receive the future control messages at the transmission time.

17. A receiver according to claim 16, wherein the selective activation module includes a processor module for extracting said transmission time information from said control messages.

18. A receiver according to claim 16, wherein the selective activation module include a controller for setting a power-up time for the receiver based on said transmission time information.

19. A receiver according to claim 18, wherein the controller is configured to set the power up time to take account of delays in powering up the receiver.

20. A receiver according to claim 18, wherein the controller is configured to monitor the power-up time and to turn on the receiver when the power-up time is reached.

21. A receiver according to claim 16, comprising a mobile receiver.

22. A mobile receiver according to claim 21, operable in accordance with the Digital Video Broadcasting DVB-H specification.

23. A receiver according to claim 16, configured to request the transmission time information independently of the control messages.

24. A method for use in a conditional access system, in which a receiver is operable to receive a plurality of control messages that are associated with transmission time information relating to a transmission time of future control messages, the method comprising selectively activating the receiver to receive the future control messages at the transmission time.

25. A method according to claim 24, further comprising incorporating said time information into each of the control messages.

26. A conditional access system, comprising:
a transmitter for transmitting a plurality of control messages, each of the messages including information relating to a predetermined transmission time for future control messages;
a receiver for receiving the control messages; and
a selective activation module for selectively activating the receiver to receive the future control message at the predetermined time.

27. A mobile transceiver for use in a conditional access system, the mobile transceiver being configured to request transmission time information for conditional access messages to be transmitted in the future, the transceiver further being configured to receive the transmission time information and to use the information to set a time for turning on a receiver to receive the messages at a time that substantially coincides with the future conditional access message transmission time.

28. A mobile transceiver according to claim 27, wherein the conditional access messages comprise entitlement management messages.

29. A mobile transceiver according to claim 27, wherein the transmission time information is sent in a messaging service format.

30. A mobile transceiver according to claim 29, wherein the messaging service format comprises SMS or MMS.

31. A method of operating a mobile transceiver in a conditional access system, the mobile transceiver being configured to request transmission time information for conditional access messages to be transmitted in the future, the transceiver further being configured to receive the transmission time information, the method comprising turning on a receiver to receive the messages at a time that substantially coincides with the future conditional access message transmission time.

32. A subscription authorisation system for use in a conditional access system to provide a plurality of control messages to a receiver, the control messages relating to a service provided to the receiver by a service provider, each of said control messages being associated with information relating to a transmission time for control messages that are to be transmitted in the future.

33. A subscription authorisation system according to claim 32, in which the control messages are provided by the service provider.

34. A subscription authorisation system according to claim 33, in which the control messages are provided from the service provider to a transmitter for onward transmission to the receiver.

35. (canceled)
